(19) United States
(12) Patent Application Publication
(10) Pub. No.: US 2006/0215055 A1
(43) Pub. Date: Sep. 28, 2006

(54) Camera lens module

(75) Inventor: Young-Kwon Yoon, Anyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/252,137

(22) Filed: Oct. 17, 2005

(30) Foreign Application Priority Data
Mar. 23, 2005 (KR) 2005-24113

(51) Int. Cl. H04N 5/225

(52) U.S. Cl. 348/342

(57) ABSTRACT

A lens module is disclosed. The lens module includes an image sensor mounted on a side of a circuit board, a filter housing mounted at a position opposite to the image sensor, and an infrared filter mounted on the filter housing. The infrared filter is aligned in optical axis with the image sensor in a state of being spaced from the image sensor. The lens module can be applied to a miniaturized appliance such as a portable terminal because it takes a form of a COF type camera lens module which is advantages in miniaturization. In addition, the lens module can minimize degradation of image quality due to foreign matters dropped on the tope surface of the infrared filter reflected to a photographed image by securing a longer distance between the image sensor and the infrared filter as compared to a conventional COF type camera lens module.

### CLAIM OF PRIORITY

This application claims priority to an application entitled “Camera Lens Module,” filed with the Korean Intellectual Property Office on Mar. 23, 2005 and assigned Serial No. 2005-24113, the contents of which are hereby incorporated by reference.

### BACKGROUND OF THE INVENTION

1. Field of the Invention

The present invention relates to a lens module, and in particular to a camera lens module capable of preventing deterioration of image quality of a photographed image by foreign matters while it is mounted in a miniaturized appliance such as a portable terminal.

2. Description of the Related Art

A digital camera converts an image signal into an electrical signal. The digital camera can also electrically execute various kinds of signal processing such as signal treatment, signal recording, signal reproducing. One expectation for such digital cameras is that they will become the primary image appliances in the multimedia age because unlike a silver salt film camera, neither working in a darkroom nor chemical treatment is needed. The digital cameras can allow for immediate confirmation of a photographed image via a display. The recorded image information may also be post-treated in the digital camera and/or transmitted to a remote location.

A conventional camera lens module for such digital cameras is mounted in a portable terminal. This allows for the application area of the camera lens module to be extended. In addition, since camera lens module may have capabilities nearly the same as that of the digital camera itself, when mounted in a portable terminal, the demarcation between a digital camera and a portable terminal mounted with a camera lens module gradually disappears among ordinary users who are not specialists.

In order to mount a camera lens module in a portable terminal, the camera lens module must, be miniaturized. It is also required that the camera lens module have a structure capable of meeting performance specifications even if it is miniaturized.

FIG. 1 is a cross-sectional view of a conventional camera lens module 100. The camera lens module 100 is a COB (Chip On Block) type camera lens module. An image sensor 103 is mounted on a circuit board 102 through wire-bonding and a lens housing 101 receiving one or more optical lenses 111 is also mounted on the circuit board 102. Within the lens housing 104, an infrared filter 104 is mounted. The optical lenses 111 and the infrared filter 104 are aligned in optical axis with the image sensor 103.

However, such a COB type camera lens module has a limit in miniaturization because a rigid circuit board is employed to mount an image sensor on the circuit board through wire-bonding.

FIG. 2 is a cross-sectional view of another conventional camera lens module 200 for a portable terminal. The camera lens module 200 is a COF (Chip On Film) type camera lens module. A flexible print circuit board is employed as a circuit board 202, and an image sensor 203 and an infrared filter 204 are mounted on the opposite sides of the circuit board 202, respectively. After mounting the image sensor 203 and the infrared filter 204, a lens housing 201 receiving one or more optical lenses 211 is mounted on the circuit board 202. Therefore, the COF type camera lens module 200 can be made smaller and hence mounted within an appliance such as a portable terminal because the thickness of the circuit board of such a COF type camera lens module can be made relatively thinner as compared to a COB type camera lens module.

It is noted that the lens focus is tuned by rotating the barrel of the lens housing after the lens housing is mounted. However, if foreign matter produced by friction due to the rotation of the barrel are dropped on the top surface of the infrared filter, the image of the foreign matters is reflected to a photographed image. This causes degradation of the camera lens module.

If the distance between the image sensor and the infrared filter is increased, the image of foreign matter reflected in a photographed image will decay due to the diffraction phenomenon of light. However, because the distance between the image sensor and the infrared filter in the COF type camera lens module is merely in the range of the thickness of the flexible circuit board, there is a problem of deteriorating the yield of the camera lens module due to the foreign matter dropped on the top surface of the infrared filter. A high performance image sensor, which has a high number of pixels, can be achieved by making fine-size unit pixels. The yield deterioration problem due to the foreign matters dropped on the top surface of the infrared filter, however, will be more severe in a camera module employing such a high performance image sensor.

### SUMMARY OF THE INVENTION

One aspect of the present invention relates to a lens module configured to reduce deterioration of image quality due to foreign matters. This improves the yield of the lens module as well as to contribute to the miniaturization of such a lens module.

One embodiment of the present inventions is directed to camera lens module including an image sensor mounted on a side of a circuit board; a filter housing mounted at a position opposite to the image sensor; and an infrared filter mounted on the filter housing. The infrared filter is aligned in optical axis with the image sensor in a state of being spaced from the image sensor.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a cross-sectional view of a conventional camera lens module;

FIG. 2 is a cross-sectional view of another conventional camera lens module;

FIG. 3 is an exploded perspective view of a camera lens module according to a first embodiment of the present invention;

FIG. 4 is a cross-sectional view of the camera lens module shown in FIG. 3;

FIG. 5 is a cross-sectional view of a camera lens module according to a second embodiment of the present invention; and

FIG. 6 is a cross-sectional view of a camera lens module according to a third embodiment of the present invention.

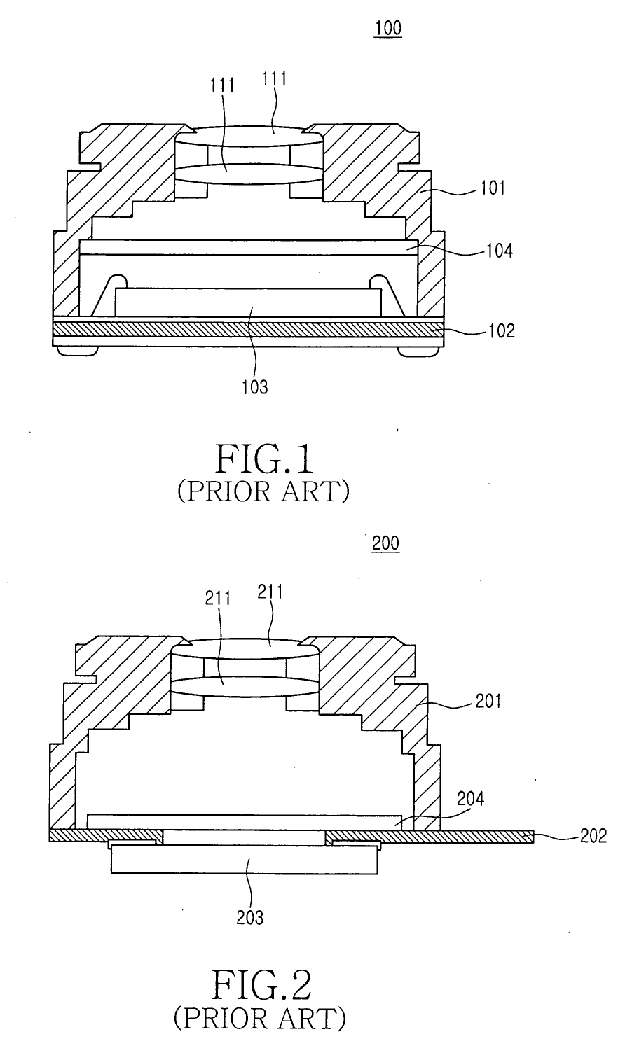

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may obscure the subject matter of the present invention.

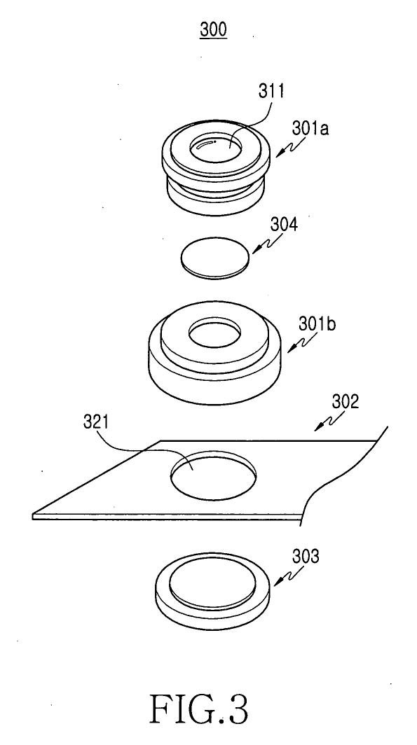

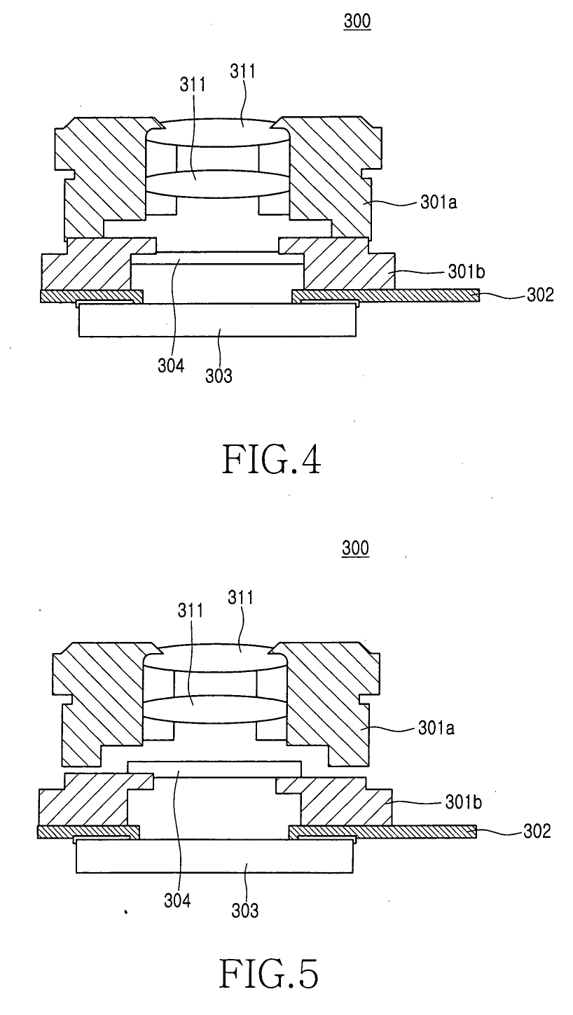

FIG. 3 is an exploded perspective view of a camera lens module 300 according to a first embodiment of the present invention. FIG. 4 is a cross-sectional view of the camera lens module 300. As shown in FIGS. 3 and 4, the camera lens module 300 includes a lens housing 301a, a filter housing 301b, a circuit board 302, an image sensor 303, and an infrared filter 304.

The lens housing 301a includes one or more optical lenses 311. In the present embodiment, the lens housing 301a serves to align a pair of optical lenses 311 on the optical axis of the image sensor 303.

The filter housing 301b is mounted on the circuit board 302. The lens housing 301a and the infrared filter 304 are coupled to the circuit board 302. The infrared filter 304 is mounted above the filter housing 301b. More specifically, in the present embodiment, the infrared filter 304 is mounted on the top end of the filter housing 301b.

The image sensor 303 is mounted on a side of the circuit board 302 i.e., on a side opposite to the filter housing 301b through a flip-chip bonding process. The infrared filter 304 and the optical lenses 311 are aligned in optical axis with the image sensor 303.

In one embodiment, the circuit board 302 is formed from a flexible printed circuit board, and the camera lens module 300 is configured as a COF type camera lens module.

The filter housing 301b secures a distance between the image sensor 303 and the infrared filter 304. A minimum distance between an image sensor and an infrared filter is 50 μm. However, in case of a COB-type camera lens module, a minimum distance of 1 mm should be maintained in order to prevent wire damage. Further, in case of a COF-type camera lens module, a minimum distance of 200 μm, which corresponds to a thickness of FPCB, should be maintained. In this way, even if foreign matters are produced and dropped on the infrared filter 304 while the barrel of the lens housing 301 is rotated to tune the focus of the lenses, it is possible to secure a distance between the infrared filter 304 and the image sensor 303 to be sufficient for the light passing through the infrared filter 304 to be diffracted. This reduces the image of the foreign matters from being reflected to a photographed image as compared to the conventional devices discussed above.

In addition to the infrared filter 304, it is noted that other types of filters or even clear materials can be used as a filter.

FIG. 5 is a cross-sectional view of a camera lens module 300 according to a second embodiment of the present invention. As shown in FIG. 5, the construction of the camera lens module 300 is substantially identical to the first embodiment in the assembled state except that the infrared filter 304 is mounted within the filter housing 301b and the lens housing 301a is integrally formed with the filter housing 301b. It is noted that the reference numerals used below in the detailed description of the camera lens module 300 of the present embodiment may be the same as those used in describing the former embodiment or omitted.

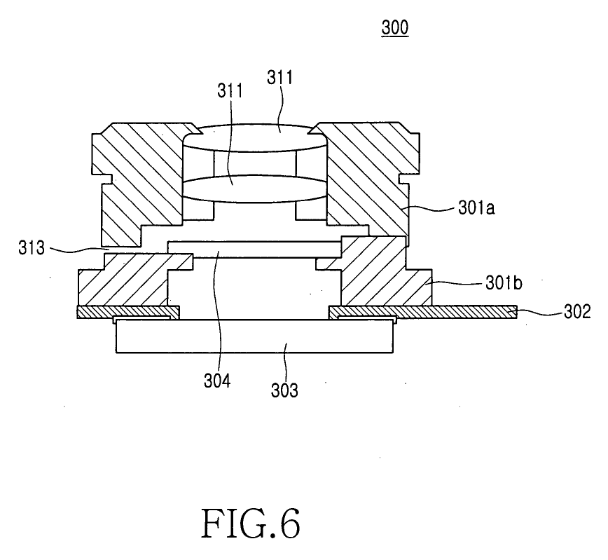

FIG. 6 is a cross-sectional view of a camera lens module 300 according to a third embodiment of the present invention. As shown in FIG. 6, the camera lens module 300 is same with those of the first and second embodiments except that a slit 311 is formed between the lens housing 301a and the filter housing 301b. It is noted again that the reference numerals used below in the detailed description of the camera lens module 300 of the present embodiment may be the same as those used in describing the former embodiments or omitted.

The lens housing 301a and the filter housing 301b can be configured either in an integrated form or in a separated form. Although it is described that the slit 311 is formed between the lens housing 301a and the filter housing 301b, it is also possible to form the slit on the outer periphery of the filter housing 301b. The infrared filter 304 of the camera lens module 300 is inserted through the slit 311 from a lateral side of the filter housing 301b.

It is preferable to perform a process of fabricating the inventive camera lens modules 300 configured in various forms as described above in a very clean working space, e.g., a clean room, from step of mounting the image sensor 303 on the circuit board 302 to step of mounting the infrared filter 304 on the filter housing. It is possible to perform the remaining steps of mounting the lens housing 301a, etc. in a less clean working space. This is to prevent foreign matters such as dusts from being interposed between the image sensor 303 and the infrared filter 304. In implementing each embodiment, the following conditions are required.

In the first embodiment, a very clean working space is required from the step of mounting the image sensor 303 on the circuit board through flip-chip bonding to the step of mounting filter housing 301b and the infrared filter 305 using adhesive such as ultraviolet (UV) curable epoxy or the like.

In the second embodiment, because the filter housing 301b and the lens housing 301a are integrally formed with each other and the infrared filter 304 is previously attached within the filter housing 301b, it is preferable that all steps including the step of mounting the lens housing 301a on the circuit board 302 along with the filter housing 301b are performed within a very clean working space.

In the third embodiment, although there may be some difference whether or not the lens housing 301a and the filter housing 301b are integrally formed with each other, a very clean working space is required at least up to the step of mounting the filter housing 301b, to which the infrared filter 304 is attached, on the circuit board 302.

After the assembly of the camera lens modules 300 is completed, the lens housing 301a is rotated to tune the focus of the lenses.

As described above, the embodiments of camera lens module can be applied to a miniaturized appliance such as a portable terminal because it takes a form of a COF type camera lens module which is advantages in miniaturization. In addition, the embodiments of camera lens module can minimize degradation of image quality due to foreign matters dropped on the tope surface of the infrared filter, which is reflected to a photographed image, by securing a longer distance between the image sensor and the infrared filter as compared to a conventional COF type camera lens module. Accordingly, the yield of the camera lens module, in particular the yield of the camera lens module employing a high performance image sensor can be improved.

While the invention has been shown and described with reference to certain embodiments thereof, it will be understood by those skilled in the art that various changes in form and details may be made therein without departing from the spirit and scope of the invention as defined by the appended claims.

1. A camera lens module comprising:
an image sensor mounted on a circuit board;
a filter housing mounted at a position opposite to the image sensor; and
an infrared filter mounted on the filter housing,
wherein the infrared filter is aligned in optical axis with the image sensor and is spaced a predetermined distance from the image sensor.

2. A camera lens module as claimed in claim 1, further comprising:
a lens housing mounted on the filter housing and positioned on the optical axis of the image sensor.

3. A camera lens module as claimed in claim 2, wherein the lens housing is integrally formed with the filter housing.

4. A camera lens module as claimed in claim 2, wherein the lens housing includes at least one optical lens, which is aligned in optical axis with the image sensor.

5. A camera lens module as claimed in claim 2, wherein a slit is formed between the filter housing and the lens housing, so that the infrared filter is inserted through the slit.

6. A camera lens module as claimed in claim 1, wherein the circuit board is a flexible printed circuit board.

7. A camera lens module as claimed in claim 1, wherein the predetermined

8. (canceled)

9. (canceled)

10. (canceled)

11. (canceled)

12. (canceled)

13. (canceled)

14. (canceled)
